(19) United States
(12) Patent Application Publication
(10) Pub. No.: US 2002/0106811 A1
(43) Pub. Date: Aug. 8, 2002

(54) Method for authentication of an item

(76) Inventor: Trent D. Jefferson, Houston, TX (US)

Correspondence Address: LUNDEEN & ARISMENDI, LLP, PO BOX 131144, HOUSTON, TX, 77219-1144, US

(21) Appl. No.: 10/063,349

(22) PCT Filed: Oct. 13, 2000
(86) PCT No.: PCT/US00/28631

(51) Int. Cl. G01N 21/76

(52) U.S. Cl. 436/172

(57) ABSTRACT

This invention relates to a method to authenticate an item comprising:combining a chelated compound with the item and thereafter detecting the presence of the chelated compound, wherein the chelated compound is present at 10 ppb to 5000 ppm and is the result of the combination of a lanthanide metal halide compound with a macrocycle compound comprising at least one pyridine moiety.

### BACKGROUND OF THE INVENTION

This invention relates to a method for authentication of an item, particularly paper currency, using certain compounds comprising a lanthanide metal.

The authentication of currency and products is an important and active area of interest for business as well as governments around the world. As printing and reproduction technologies become cheaper and more accessible to the general public, so too the risk of counterfeiting currency or goods becomes greater. Likewise as soon as one means is devised to detect counterfeiting, another means is usually devised to circumvent it. Thus there is a constant need for both industries and governments to develop new means to detect counterfeits and/or to authenticate originals.

Attempts to address these authentication issues with regard to currency include using organic chelates derived from lanthanide metals as fluorescent markers for time resolved fluorometric assays. See E. P. Diamandis, Clin. Biochem. 21, 139-150 (1988);

Clin. Chim. Acta. 19, 19-50(1990); Anal. Chem 62, 11 49A-11 57A (1990): E. Soini and T. Lovgren, Crit. Rev.,Anal. Chem. 18,105-154 (1987). It has been shown that the amount of light that is emitted in the visible spectrum, when the complex is exposed to ultraviolet light, is increased when such organic chelates are complexed with selected larger organic molecules. See A.P.B. Sinha, Fluoresence and Laser Action in Rare Earth Chelates/Spectroscopy in Inorganic Chemistry, Volume II Academic Press (1971). See also for example, U.S. Pat. No. 5,312,922, which discloses the use of terbium and europium complexes for a currency marking application. These complexes however must be used in large quantities to obtain an acceptable amount of visible light when the complexes fluoresce under UV light.

### SUMMARY OF INVENTION

This invention relates to a method for authentication of items, particularly currency, negotiable and non-negotiable instruments printed on paper, other items comprising cellulosic fiber, and consumer goods in general, using certain chelated compounds comprising a lanthanide metal halide compound (the lanthanide metal halide compound is preferably represented by the formula MXₐ where M is a lanthanide metal, X is a halide, and a is a number from 1 to 5) that has been combined with a macrocyclic compound represented by the following formulae:

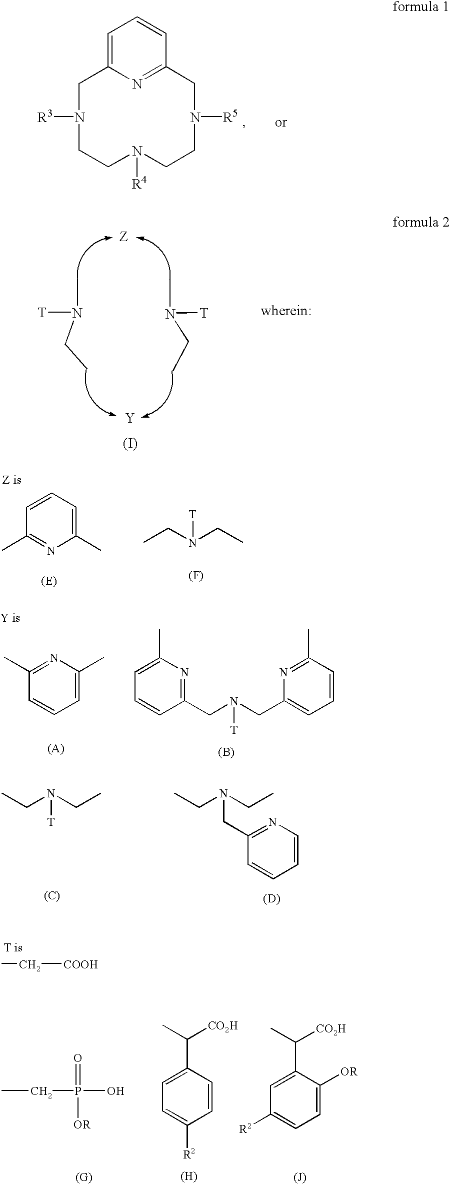

and

R is hydrogen, C₁ to C₄ alkyl, —CH₂ CF₃, R² is NO₂, NH₂, isothiocyanate, semicarbazido, thiosemicarbazido, maleimido, bromoacetamido, or carboxyl group, N is nitrogen, and each R³, R⁴ and R⁵ group may independently be hydrogen, a group comprising 1 to 100 carbon atoms, a heteroatom containing group, a C₁ to C₁₀₀ alkyl group, ester, an aromatic ring (substituted or unsubstituted), a group forming a pyridine ring with the nitrogen or an acid, 1 to 3 additional R* groups can be present on the pyridine ring at the top of the above formula. (R* is as defined for R³, R⁴ and R⁵ above.) and wherein the macrocycle comprises at least one pyridine moiety.

The method includes the steps of combining a detectable amount of the chelated compound with the item, circulating the item, e.g. through a series of transactions between third parties, and thereafter irradiating the item with an electromagnetic source and observing a response to detect the presence of the chelated compound and thereby authenticate the item.

The chelated compound is preferably included in the material comprising the good or currency, the good or currency is then placed under a detector and a light or other energy response is obtained. For example the chelated compound may fluoresce or may generate a magnetic field, an infrared field or other energy field to confirm its authenticity. As another example, different light irradiating sources may generate the same or different fluorescence, magnetic field or infrared emissions characteristic of the particular chelated compound.

### DETAILED DESCRIPTION

This invention relates to a method for authentication of items, particularly currency and consumer goods, using certain chelated compounds comprising a lanthanide metal halide compound (in a preferred embodiment the lanthanide halide is represented by the formula MXₐ where M is a lanthanide metal, preferably terbium, europium, samarium, yttrium, or gadolinium, more preferably europium, terbium or yttrium, X is a halide, preferably chloride, fluoride, or bromide, more preferably chloride, and a is a number from 1 to 5), that has been combined with a macrocyclic compound represented by the following formulae:

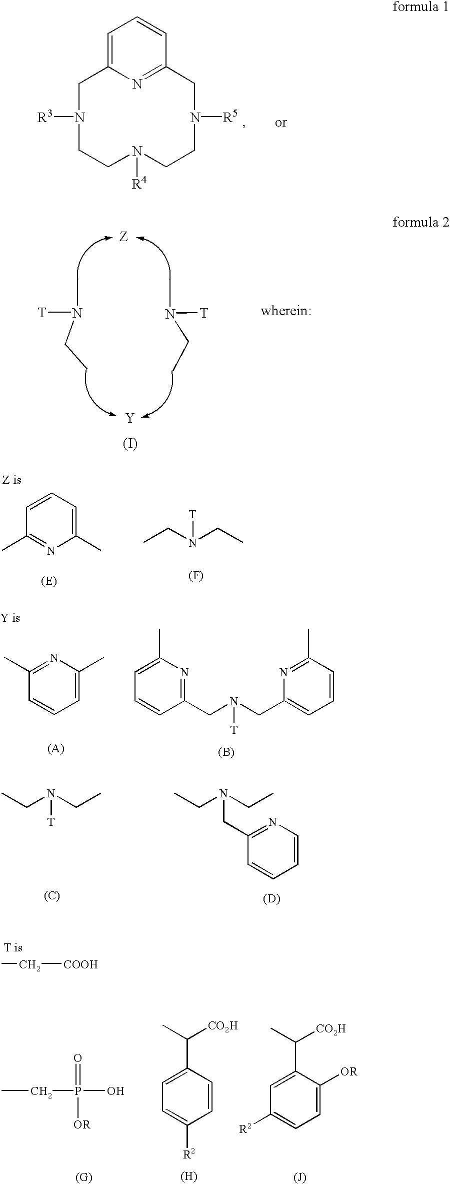

and

R is hydrogen, C₁ to C₄ alkyl, —CH₂ CF₃, R² is NO₂, NH₂, isothiocyanate, semicarbazido, thiosemicarbazido, maleimido, bromoacetamido, or carboxyl group, N is nitrogen, and

each R³, R⁴ and R⁵ group may independently be hydrogen, a group comprising 1 to 1 00 carbon atoms, a heteroatom containing group, a C₁ to C₁₀₀ alkyl group, ester, an aromatic ring (substituted or unsubstituted), a group forming a pyridine ring with the nitrogen or an acid, preferably an alkyl group, a carboxylic acid group, an acetate group, an acrylate group, an alcohol group, a halide group a metallic acid, a thio sulfate or combinations thereof. Preferably each R³, R⁴ and R⁵ group may independently be a halide, an acetate, an alkyl, a phosphonate, an epoxy, or a combination thereof. Preferred acetates include those having 1 to 40 carbon atoms. Preferred acetates include linear, branched or cyclic C₁ to C₂₀ alkyl acetates, such as ethyl acetate, methyl acetate, n-butyl acetate, i-butyl acetate, n-propyl acetate, i-propyl acetate, pentyl acetate, hexyl acetate, heptyl acetate, octyl acetate, nonyl acetate, decyl acetate, isooctylnonyl acetate, cyclohexyl acetate, cyclopentyl acetate, 3,5,5-trimethylhexyl acetate, cyclopentadienyl acetate, and combinations thereof. In a preferred embodiment the pyridine ring or rings can be substituted with 1 to 3 additional R* groups, wherein R* is as defined for R³, R⁴ and R⁵ above. In another preferred embodiment, a plurality of the nitrogens are formed into pyridine rings, substituted or not with additional R* groups and wherein the macrocycle comprises at least one pyridine moiety.

each R³, R⁴ and R⁵ group may independently be hydrogen, a group comprising 1 to 1 00 carbon atoms, a heteroatom containing group, a C₁ to C₁₀₀ alkyl group, ester, an aromatic ring (substituted or unsubstituted), a group forming a pyridine ring with the nitrogen or an acid, preferably an alkyl group, a carboxylic acid group, an acetate group, an acrylate group, an alcohol group, a halide group a metallic acid, a thio sulfate or combinations thereof. Preferably each R³, R⁴ and R⁵ group may independently be a halide, an acetate, an alkyl, a phosphonate, an epoxy, or a combination thereof. Preferred acetates include those having 1 to 40 carbon atoms. Preferred acetates include linear, branched or cyclic C₁ to C₂₀ alkyl acetates, such as ethyl acetate, methyl acetate, n-butyl acetate, i-butyl acetate, n-propyl acetate, i-propyl acetate, pentyl acetate, hexyl acetate, heptyl acetate, octyl acetate, nonyl acetate, decyl acetate, isooctylnonyl acetate, cyclohexyl acetate, cyclopentyl acetate, 3,5,5-trimethylhexyl acetate, cyclopentadienyl acetate, and combinations thereof. In a preferred embodiment the pyridine ring or rings can be substituted with 1 to 3 additional R* groups, wherein R* is as defined for R³, R⁴ and R⁵ above. In another preferred embodiment, a plurality of the nitrogens are formed into pyridine rings, substituted or not with additional R* groups and wherein the macrocycle comprises at least one pyridine moiety.

The selection of the lanthanide metal will depend on the desired response during authentication. If a fluorescence is desired then metals such as europium, terbium and yttrium are preferred, while if a magnetic response is desired then samarium is preferred, and gadolinium is preferred for an infrared responsive complex. In addition, other metals or metal compounds may be added or used in combination with those of the present invention. For example iron or iron complexes may be used in combination with the samarium to enhance the magnetic response.

Preferred compounds include those of formula 1 where R³, R⁴ and R⁵ are acetates, preferably ethyl, propyl or butyl acetate or a combination thereof and the lanthanide metal compound comprises terbium or europium, or a combination thereof.

In a preferred embodiment the macrocycle compound comprises 2 or more pyridine moieties. In another preferred embodiment the macrocycle compound comprises 3 or more pyridine moieties. In a further preferred embodiment the macrocycle compound comprises 4 or more pyridine moieties.

Preferred macrocycle compounds include 1, 4, 7, 10, Bicyclopolyazamacrocycloacetate possessing at least one pyridine moiety.

Methods for making the chelated compound include methods known in the art, such as, for example U.S. Pat. No. 5,928,627. In general, one simply combines the lanthanide metal halide with the macrocycle compound, optionally in a liquid such as a solvent, and allows them to react. Heat can be applied, if desired. Preferred liquids include water, alcohols, furans (such as tetrahydrofuran). Depending on the polarity of the T groups, any organic liquid can be used, including aliphatics, hydrocarbon solvents and the like.

Preferably the chelated compound is included in the composition making up a currency or good. For example, in one embodiment, the chelated compound is added to a paper slurry before the paper is dried and printed upon. Alternatively, the chelated compound can be mixed in the ink used to print on the paper, or applied by itself in a pattern by printing with a solution or mixture containing the chelated compound. Then once the paper is in circulation one can simply place the paper under a device, such as an ultraviolet light, or a magnetometer, a heat sensor or the like to obtain the characteristic fluorescence, magnetic or infrared telltale response.

In another example one can include the chelated compound in a plastic composition, such as a plastic used in a credit card or a polycarbonate used in compact disc manufacture, a metal or metal alloy such as those for golf clubs or coins, cloth or leather, such as cloth used in designer clothing or accessories.

The instant invention can be practiced with metal compositions, paper compositions, cloth compositions, plastic compositions, elastomer compositions, laminate compositions, and the like. In fact this invention can be practiced in any material or composition that dyes or colorants are used in.

Preferred plastics include ethylene homo and co-polymers such as high density polyethylene, low density polyethylene, ethylene vinyl acetates, ethylene acrylates, and the like. Preferred plastics also include propylene homo and co-polymers such as high polypropylene and the like. Additional preferred plastics include PVC, polycarbonates and the like. Preferred elastomers include butyl rubber, EPM rubber, EPR rubber, styrene-butadiene rubber (block or random), polyisoprene and the like.

Particularly this invention can be practiced in any of the following areas:—Fiduciary articles (stocks, bonds, paper and metal currency, credit cards, checks)—Electronic media (magnetic recording, compact disks, data tapes and other carriers)—Apparel (threads, fabrics, identification tags and labeling)—Mechanical parts for transportation equipment (ground, air and nautical vessels)—Primary and or redundant features for security products (holograms, encoding, encryption, etc.)—Material additives (polymers, paper, adhesives, coatings, colorants)—Sporting goods—Chemical products (composite materials, petroleum goods, personal care formulations)—Consumer and office products, ink or ink pens, laser jet cartridge inks, water marked paper and the like.

Typically the chelated compound can be present at about 10 parts per billion (ppb) to about 5000 parts per million (ppm) in the material marking, typically a currency composition, more preferably about 1 5 ppb to about 3000 ppm, more preferably about 20 ppb to about 1000 ppm, more preferably about 25 ppb to about 750 ppm, more preferably about 30 ppb to about 500 ppm, especially about 30 ppb to about 250 ppm, more preferably about 30 ppb to about 100 ppm, more preferably about 30 ppb to about 50 ppm, more preferably about 30 ppb to about 10 ppm.

The chelated compounds of this invention have a larger response per unit volume than compounds in the prior art used for similar applications. Thus less of the chelated compound can be used to achieve a greater authentication response at a substantial savings.

Preferred chelated compounds of this invention that fluoresce, do so at more lumens per unit volume than other indicators, typically 2 to 5 times greater.

Electromagnetic energy is measured in frequency or wavelength by use of a spectrometer. Emissions in the visible region typically range from a frequency of at least 4 to 7.5×10¹⁴ Hz. The present invention preferably uses chelated compounds that have a response of at least 4×10¹⁴ Hz.

Where an infrared response is observed, the chelated compound in the present method has a minimum heat response that is at least 100 Pico calories measured with a calorimeter.

The present invention has a magnetic response of at least 50 mT measured with a Teslameter Gauss (1 Gauss=Tesla×10⁴) is a-current minimum value to detect a managetic response.

The lanthanide-chelated macrocycle compounds used in the authentication method of this invention have high chemical stability. They do not generally degrade any faster than the currency or other article to which they are applied, and can be used for authentication purposes long after initial application or placement. Depending on the solubility, generally depending on the type of R groups and the macrocycle, the chelated compound is not substantially adversely affected by extractive processes such as water wetting of currency, washing, or the like.

The chelated compounds of the present methodology also have improved versatility for different ranges of applications. For example, by using aliphatic subsituent R groups on the macrocycle, the chelated compounds can have a lipid affinity which is useful in olefinic polymers. Conversely, by using acidic substituents such as acetates the chelated compound can have an affinity to materials like paper, wood and wood or cellulosic products.

The chelated compound also has a characteristic x-ray diffraction index indicative of a consistent elemental signature ratio of carbon:nitrogen:lanthanide. This can be helpful in using x-ray diffraction equipment to measure the diffraction index as another authentication step, especially in contrast against the diffraction index of the unmarked portions of article, for example, with portable or hand-held x-ray diffraction equipment.

In addition, the chelated compound can have an electrically conductive organic structure, due to overlapping p-orbitals (free electrons) in the macrocyclic ring. If desired, this can provide a further authentication responsive signature that is characteristic of the presence of the chelated compound. The authentication method can thus optionally include measuring the electrical conductivity and/or resistivity of the area of the article to which the chelated compound has been applied in an authentic article.

Another benefit of the present authentication method arises from the use of a chelated compound in an embodiment wherein the lanthanide is terbium or europium, in that the chelated compound exhibits absorption of long wave UV irradiation, and a characteristically different emission in the visible spectrum upon irradiation with a short or narrow wavelength UV source. For example, irradiation with a UV spectrum at 235 350 nm can result in visible fluorescence that is similar to other compounds with fluorescent response, but upon irradiation with 280 325 nm UV exhibits a strikingly brighter fluorescence, in contrast to the other compounds which exhibit substantially the same response regardless of the UV wavelength. Thus, the authentication method can include the steps of irradiating the article with two different UV sources and comparing the relative fluorescent response of the article thereto. In this manner, the authenticity of the article can be determined by observing, either with the naked eye or a spectrophotometric tool, the presence or absence of the two (or more) characteristic fluorescent responses. The quantum efficiency of the chelated compound is substantially greater than the 10 percent which has been the maximum observed in the prior art authentication methods with lanthanides, preferably at least 25 percent, and more preferably approaching 50 percent.

### EXAMPLE 1

Five moles of terbium trichloride were combined with 5 moles of

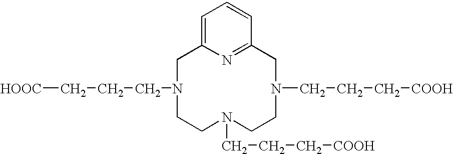

in 10 ml of tetrahydrofuran. Two drops (about 10 μ liters) of the solution were then painted onto a five dollar bill. The bill was allowed to dry and then placed under an ultraviolet light source. The painted area fluoresced brightly.

### EXAMPLE 2

Five moles of samarium trichloride is combined with 5 moles of

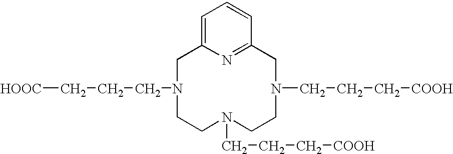

in 10 ml of tetrahydrofuran. Two drops (about 10 μ liters) of the solution is then painted onto a five dollar bill. The bill is allowed to dry and then placed under a heat lamp or sufficient electrical current is applied and the responsive infrared emission is measured with a calorimeter or spectrometer. The painted area exhibits an infrared response.

### EXAMPLE 3

Five moles of gadolinium trichloride is combined with 5 moles of

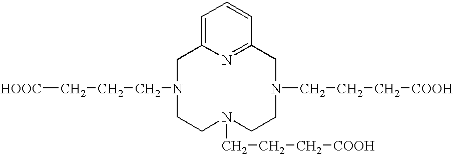

in 10 ml of tetrahydrofuran. Two drops (about 10 μ liters) of the solution is then painted onto a five dollar bill. The bill is allowed to dry and then placed under a Teslameter with an electric current applied across either end of the painted area. The painted area shows a magnetic response.

1. A method to authenticate an item comprising:
combining a detectable amount of a chelated compound with the item;
circulating the item; and
thereafter irradiating the item with an electromagnetic source and observing a respon detect the presence of the chelated compound and thereby authenticate the item;
wherein the chelated compound is the result of the combination of a lanthanide metal compound with a macrocycle compound wherein the macrocycle is represented by the formulae: 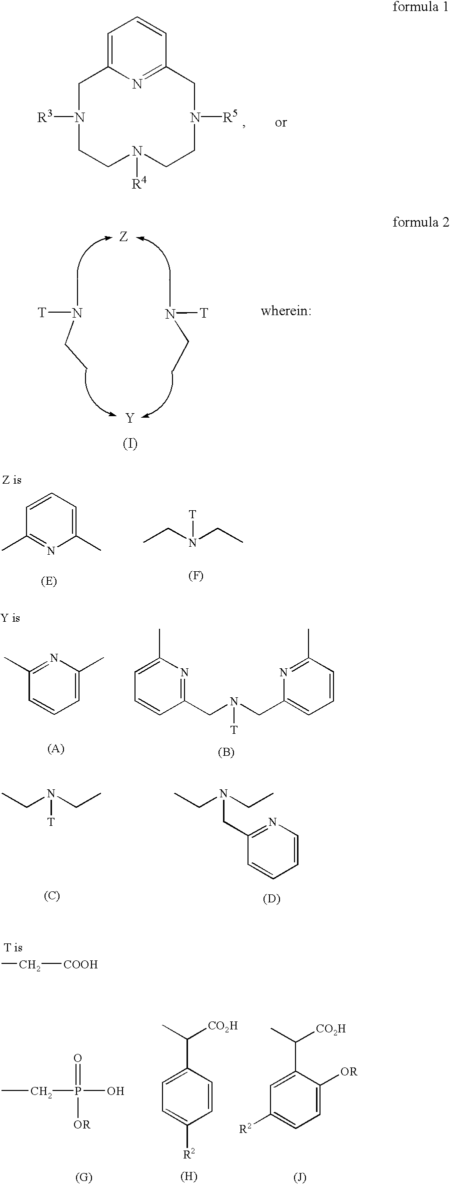
wherein R is hydrogen, C₁ to C₄ alkyl, or a —CH CF₃ group, R² is NO₂, NH₂, isothioc semicarbazido, thiosemicarbazido, maleimido bromoacetamido, or a carboxy group, M is a lanthanide metal, N is nitrogen, and each R³, R⁴ and R⁵ group may independently be hyd group comprising 1 to 100 carbon atoms, a heteroatom containing group, a C₁ to C₁₀₀ al group, ester, an aromatic ring (substituted or unsubstituted), or a group forming a pyridine with the nitrogen or an acid, wherein the macrocycle comprises at least one pyridine moiety

2. The method of claim 1, wherein the item is paper.

3. The method of claim 1 where the item is currency.

4. The method of claim 1 wherein the lanthanide metal halide is represented by the compound MXₐ, where M is a lanthanide metal, X is a halide and a is a number from 1 to 5.

5. The method of claim 4 wherein M is terbium, samarium, europium, dysprosium, gadolinium or yttrium.

6. The method of claim 4 wherein the halide is chloride, bromide or fluoride.

7. The method of claim 1 wherein each R³, R⁴ and R⁵ group is independently hydrogen, an alkyl group, a carboxylic acid group, an acetate group, an acrylate group, an alcohol group, a halide group a metallic acid, a thio sulfate or any combination thereof.

8. The method of claim 1 wherein each R³, R⁴ and R⁵ group is independently an acetate having 1 to 40 carbon atoms.

9. The method of claim 1 wherein each R³, R⁴ and R⁵ group is independently a linear, branched or cyclic C₁ to C₂₀ alkyl acetate.

10. The method of claim 1 wherein each R³, R⁴ and R⁵ group is independently selected from the group consisting of ethyl acetate, methyl acetate, n-butyl acetate, i-butyl acetate, n-propyl acetate, i-propyl acetate, pentyl acetate, hexyl acetate, heptyl acetate, octyl acetate, nonyl acetate, decyl acetate, isooctylnonyl acetate, cyclohexyl acetate, cyclopentyl acetate, 3,5,5-trimethylhexyl acetate, cyclopentadienyl acetate, and combinations thereof.

11. The method of claim 1 wherein each nitrogen is formed into a pyridine ring.

12. The method of claim 1 wherein the macrocycle comprises at least two pyridine moieties.

13. The method of claim 1 wherein the macrocycle comprises at least three pyridine moieties.

14. The method of claim 1 wherein the lanthanide metal comprises europium or terbium, the macrocycle is represented by formula 1 and R³, R⁴ and R⁵ comprise acetates.

15. The method of claim 1 wherein the item comprises cloth or leather.

16. The method of claim 1 wherein the item comprises a metal.

17. The method of claim 1 wherein the item comprises polycarbonate.

18. The method of claim 14 wherein the item comprises paper.

19. The method of claim 1 wherein the item comprises plastic.

20. The method of claim 1 wherein the item comprises ink.

21. The method of claim 1 comprising irradiation of the article with a second electromagnetic source and observing for a response characteristic of the chelated compound.

22. The method of claim 1 comprising the further step of subjecting the article to electrical current and observing for a response characteristic of the chelated compound.

23. The method of claim 1 comprising the further step of subjecting the article to x-ray diffraction and observing for a response characteristic of the chelated compound.

24. The method of claim 1 comprising the further step of subjecting the article to infrared radiation and observing for a response characteristic of the chelated compound.
